(19) United States
(12) Patent Application Publication
(10) Pub. No.: US 2007/0161746 A1
(43) Pub. Date: Jul. 12, 2007

(54) Thermoplastic Molding Masses Made From Styrol Copolymers And Polyamides

(76) Inventor: Martin Weber, Maikammer (DE)

Correspondence Address: CONNOLLY BOVE LODGE & HUTZ, LLP, P O BOX 2207, WILMINGTON, DE, 19899, US

(21) Appl. No.: 10/586,384

(22) PCT Filed: Jan. 15, 2005
(86) PCT No.: PCT/EP05/00380

§ 371 Date: Jul. 19, 2006

(30) Foreign Application Priority Data
Jan. 27, 2004 (DE) 102004004230.6

(51) Int. Cl. C08L 77/00

(52) U.S. Cl. 525/66

(57) ABSTRACT

Thermoplastic molding compositions composed of A) a polyamide having amino or carboxy end groups or a mixture of these end groups, B) a mixture composed of at least two graft copolymers, each comprising a rubber as graft base and a graft based on an unsaturated monomer, where these differ at least 5% by weight from one another in their rubber contents, C) a rubber-free copolymer, comprising c1) at least 30% by weight, based on the total weight of all of the units present in C), of units which derive from a vinylaromatic monomer, c2) units which derive from a monomer which comprises a functional group which can react with the end groups of the polyamide A), and c3) units which derive from a monomer which comprises no functional groups which react with the end groups of the polyamide A), and also moreover, if desired, D) a rubber-free matrix polymer, E) a low-molecular-weight compound which comprises a dicarboxylic anhydride group, and F) an additive, or a mixture of various additives.

The present invention relates to thermoplastic molding compositions composed of
A) a polyamide having amino or carboxy end groups or a mixture of these end groups,
B) a mixture composed of at least two graft copolymers, each comprising a rubber as graft base and a graft based on an unsaturated monomer, where these differ at least 5% by weight from one another in their rubber contents,
C) a rubber-free copolymer, comprising
   c1) at least 30% by weight, based on the total weight of all of the units present in C), of units which derive from a vinylaromatic monomer,
   c2) units which derive from a monomer which comprises a functional group which can react with the end groups of the polyamide A), and
   c3) units which derive from a monomer which comprises no functional groups which react with the end groups of the polyamide A),
   and also moreover, if desired,
D) a rubber-free matrix polymer,
E) a low-molecular-weight compound which comprises a dicarboxylic anhydride group, and
F) an additive, or a mixture of various additives.

The present invention moreover relates to a process for preparing these molding compositions. The present invention also relates to the use of these molding compositions for producing moldings, films, fibers, or foams. This invention also comprises moldings, films, fibers, or foams obtainable from these molding compositions. Further embodiments of the present invention are found in the claims, in the description, and in the examples. Without going beyond the scope of the invention it is, of course, also possible to use the features which have been mentioned above, and those which will be mentioned below, for the inventive molding compositions not only in the specific stated combination but also in other combinations.

Blends in which polyamide and ABS-type plastics are present are known. It is also known that blends of this type can be mixed with polymers which have functional groups that can react with the end groups of the polyamide. These polymers act as compatibilizer between the polyamide phase and the phase formed by the ABS-type plastics. The result is to improve the properties of the blends, and in particular the impact strengths are substantially increased.

Blends of this type are known, inter alia, from EP-A 202 214, EP-A 402528 and EP-A 784 080. Those specifications disclose blends each of which comprises a graft rubber described in more detail via its rubber content, and also, for example, via its gel content, its molecular weight, and its particle size. According to EP-A 784 080, the rubber of the graft copolymer cannot contain any groups which can react with the end groups of the polyamide.

EP-A 220 155 discloses blends which comprise, besides the polyamide, the compatibilizing component, and the graft rubber, an acid-containing acrylate copolymer rubber for further improvement in impact strength.

When moldings composed of plastics are used in apparatus which comprise moving parts that cause vibration, the plastics parts are often found to emit unacceptable noise. In particular in the vehicle production sector, there is the particular problem of sound-deadening associated with the use of plastics parts. It was therefore an object of the present invention, starting from the known blends and retaining the known good mechanical properties of these, to find molding compositions which have good frictional properties, thus permitting reduction of noise caused by vibration, in particular squeaking.

Accordingly, the molding compositions defined at the outset have been found, and moreover have improved flowability together with improved notched impact strength when compared with the known blends.

Component A

For the purposes of the present invention, polyamides are homopolymeric or copolymeric, synthetic long-chain polyamides in which repeating amide groups are a substantive constituent of the main polymer chain. Examples of these polyamides are nylon-6 (polycaprolactam), nylon-6,6 (polyhexamethyleneadipamide), nylon-4,6 (polytetramethyleneadipamide), nylon-6,10 (polyhexamethylenesebacamide), nylon-7 (polyenantholactam), nylon-11 (polyundecanolactam), nylon-12 (polydodecanolactam). As is known, these polyamides have the generic name nylon.

There are in principle two processes for preparing polyamides.

Polymerization starting from dicarboxylic acids and from diamines, as with polymerization starting from amino acids, reacts the amino and carboxy end groups of the starting monomers or starting oligomers with one another to form an amide group and water. The water can then be removed from the polymeric material. The polymerization starting from carboxamides reacts the amino and amide end groups of the starting monomers or starting oligomers with one another to form an amide group and ammonia. The ammonia can then be removed from the polymeric material.

Examples of suitable starting monomers or starting oligomers for preparing polyamides are
(1) C₂-C₂₀, preferably C₃-C₁₈, amino acids, such as 6-aminocaproic acid, 11-aminoundecanoic acid, and also dimers, trimers, tetramers, pentamers and hexamers thereof,
(2) amides of C₂-C₂₀ amino acids, for example 6-aminocaproamide, 11-aminoundecanamide, and also dimers, trimers, tetramers, pentamers and hexamers of these,
(3) products of the reaction of
   (3a) C₂-C₂₀, preferably C₂-C₁₂, alkylenediamines, such as tetramethylenediamine or preferably hexamethylenediamine, with
   (3b) a C₂-C₂₀, preferably C₂-C₁₄, aliphatic dicarboxylic acid, such as sebacic acid, decanedicarboxylic acid or adipic acid, and also dimers, trimers, tetramers, pentamers and hexamers of these reaction products,
(4) products of the reaction of (3a) with
   (4b) a C₈-C₂₀, preferably C₈-C₁₂, aromatic dicarboxylic acid or derivatives thereof, for example chlorides, e.g. 2,6-naphthalenedicarboxylic acid, preferably isophthalic acid or terephthalic acid,
   and also dimers, trimers, tetramers, pentamers and hexamers of these reaction products,
(5) products of the reaction of (3a) with
   (5b) a C₉-C₂₀, preferably C₉-C₁₈, arylaliphatic dicarboxylic acid or derivatives thereof, for example chlorides, e.g. o-, m- or p-phenylenediacetic acid,
   and also dimers, trimers, tetramers, pentamers and hexamers of these reaction products,
(6) products of the reaction of
   (6a) C₆-C₂₀, preferably C₆-C₁₀, aromatic diamines, such as m- or p-phenylenediamine, with (3b),
   and also dimers, trimers, tetramers, pentamers and hexamers of these reaction products,
(7) products of the reaction of
   (7a) C₇-C₂₀, preferably C₈-C₁₈, arylaliphatic diamines, such as m- or p-xylylenediamine, with (3b),
   and also dimers, trimers, tetramers, pentamers and hexamers of these reaction products, and
(8) monomers or oligomers of a C₂-C₂₀, preferably C₂-C₁₈, arylaliphatic or preferably aliphatic lactam, such as enantholactam, undecanolactam, dodecanolactam or caprolactam,
   and also homopolymers or copolymers or mixtures of these starting monomers or starting oligomers.

Preference is given here to those starting monomers or starting oligomers which during the polymerization give the polyamides nylon-6, nylon-6,6, nylon-4,6, nylon-6,10, nylon-7, nylon-11, or nylon-12, in particular nylon-6 or nylon-66. A mixture of two or more of these polyamides may also be used as component A).

Nylon-6 is very particularly preferably used as polyamide A).

According to the invention, the end groups of the polyamide A) are amino or carboxy end groups, or a mixture thereof. The polyamides A) used here may comprise those which have an excess of amino end groups or else those which have an excess of carboxy end groups. The polyamides A) used preferably comprise those which have an excess of carboxy end groups.

The content of component A) in the inventive molding compositions may vary widely. Preferred inventive molding compositions comprise amounts of from 5 to 95.05% by weight, in particular from 7.5 to 91.599% by weight, of component A), based on the total weight of the molding composition. Particularly preferred molding compositions comprise from 10 to 89.15% by weight of component A), based on the total weight of the molding composition.

Component B

According to the invention, a mixture composed of two or more, for example from three to five, different graft copolymers is used as component B). The mixture preferably comprises two different graft copolymers.

Each of the graft copolymers comprises a rubber as graft base and a graft. According to the invention, this is to be interpreted as including the possibility that two or more soft phases (i.e. rubber phases) and two or more hard phases may be present. According to the invention, the graft copolymers differ from one another at least in the content of rubber in % by weight, based on the total weight of graft copolymer and calculated on the basis of the amount of starting material. This content difference is at least 5% by weight according to the invention. In one of the preferred embodiments, the difference in rubber content is at least 6% by weight, for example from 6 to 10% by weight. According to the invention, the rubber content here is intended to mean the entire content of soft phases in each graft copolymer.

The graft copolymers may have the same structure in other respects. However, they may also be based on rubbers of different monomeric composition, or have a different graft. They may moreover have not only a different graft base but also a different graft, for example a different sequence of soft and hard phases, or may be based on different monomeric units.

In principle, rubbers suitable as graft base are all of those whose glass transition temperature is 0° C. (determined to DIN 53765) or below. The rubbers may be of very different type. By way of example, silicone rubbers, olefin rubbers, such as ethylene rubbers, propylene rubbers, ethylene-propylene rubbers, EP(D)M rubbers, block rubbers, such as styrene-ethylene-butadiene-styrene (SEBS) rubbers, diene rubbers, acrylate rubbers, ethylene-vinyl acetate rubbers, or ethylene-butyl acrylate rubbers may be used.

Preferred silicone rubbers comprise, as organic radicals, at least 80 mol % of methyl groups. The end group is generally a diorganylhydroxysiloxy unit, preferably a dimethylhydroxysiloxy unit. Crosslinked silicone rubbers are particularly preferably used as graft base c1). By way of example, these may be prepared by a first stage in which silane monomers, such as dimethyidichlorosilane, vinylmethyldichlorosilane, or dichlorosilanes having other substituents, are reacted to give cyclic oligomers. In a further stage, crosslinked silicone rubbers may be obtained by ring-opening polymerization of the cyclic oligomers with addition of crosslinking agents, such as mercaptopropylmethyldimethoxysilane. The diameter of the silicone rubber particles (weight average d₅₀) is generally from 0.09 to 1 μm, with preference from 0.09 to 0.4 μm (determined as in W. Scholtan and H. Lange, Kolloid-Z. und Z.-Polymere 250 (1972), pp 782-796, by means of an ultracentrifuge).

The EP(D)M rubbers suitable as graft base are co- or terpolymers which contain at least one ethylene unit and one propylene unit, and preferably a small number of double bonds, i.e. fewer than 20 double bonds per 1000 carbon atoms. The terpolymers generally comprise at least 30% by weight of units which derive from ethylene and at least 30% by weight of units which derive from propylene, based on the total weight of the terpolymer. Other units present in the terpolymers generally comprise diolefins having at least five carbon atoms. Processes for their preparation are known per se. The diameters of the EP(D)M rubber particles (weight average d₅₀) are generally in the range from 0.05 to 10 μm, preferably from 0.1 to 5 μm, in particular from 0.15 to 3 μm (determined as stated above by means of an ultracentrifuge).

Acrylate rubbers which may be used are in particular polymers composed of alkyl acrylates, where these may comprise up to 40% by weight of other copolymerizable monomers, based on the total weight of the acrylate rubber. Preference is given to C₁-C₈-alkyl esters, e.g. methyl esters, ethyl esters, butyl esters, n-octyl esters, and 2-ethylhexyl esters, or a mixture of the esters mentioned. Crosslinked acrylate rubbers are particularly preferably used as graft base. Processes for their preparation are familiar to the person skilled in the art. The diameters of their particles are generally in the range of those mentioned for the EP(D)M rubbers.

Acrylate rubbers and diene rubbers are preferred as graft base.

However, particular preference is given to using diene rubbers as graft rubbers. As graft base, very particular preference is given to diene rubbers which are composed of
b11) from 50 to 100% by weight of at least one diene having conjugated double bonds, and
b12) from 0 to 50% by weight of one or more other monoethylenically unsaturated monomers,
   the percentages by weight of b11) and b12) giving a total of 100.

The dienes which may be used and have conjugated double bonds, b11), may in particular comprise butadiene, isoprene, and halogen-substituted derivatives of these, such as chloroprene. Preference is given to butadiene or isoprene, in particular butadiene.

Examples of the other monoethylenically unsaturated monomers b12) which may be present with concomitant reduction in the amounts of the monomers b11) in the diene rubber are:

vinylaromatic monomers, preferably styrene or styrene derivatives, such as C₁-C₈-alkyl-substituted styrenes, e.g. α-methylstyrene, p-methylstyrene, vinyltoluene; unsaturated nitriles, such as acrylonitrile or methacrylonitrile; aliphatic esters, such as C₁-C₄-alkyl esters of methacrylic or acrylic acid, e.g. methyl methacrylate, and also the glycidyl esters, glycidyl acrylate and glycidyl methacrylate;

N-substituted maleimides, such as N-methyl-, N-phenyl-, and N-cyclohexylmaleimide; acids, such as acrylic acid, methacrylic acid; and dicarboxylic acids, such as maleic acid, fumaric acid, and itaconic acid, and also their anhydrides, such as maleic anhydride; nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide, and methacrylamide;

aromatic and araliphatic esters of (meth)acrylic acid, such as phenyl acrylate, phenyl methacrylate, benzyl acrylate, benzyl methacrylate, 2-phenylethyl acrylate, 2-phenylethyl methacrylate, 2-phenoxyethyl acrylate, and 2-phenoxyethyl methacrylate; unsaturated ethers, such as vinyl methyl ether or vinyl butyl ether.

It is, of course, also possible to use a mixture composed of two or more of these monomers.

Preferred monomers b12) are styrene, acrylonitrile, methyl methacrylate, glycidyl acrylate, glycidyl methacrylate, or butyl acrylate.

The preparation of the rubbers is known to the person skilled in the art, or may be carried out using methods known to the person skilled in the art. By way of example, the diene rubbers may be prepared by a first step in which they are not produced in particle form, examples of methods here being solution polymerization or gas-phase polymerization, the polymers then being dispersed in the aqueous phase in a second step (secondary emulsification). For the preparation of the rubbers, preference is given to heterogeneous polymerization processes which form particles. This dispersion polymerization may be conducted, by way of example, in a manner known per se by the emulsion polymerization, inverse emulsion polymerization, miniemulsion polymerization, microemulsion polymerization, or microsuspension polymerization method, using a feed process, continuously, or using a batch process. The rubbers may also be prepared in the presence of a fine-particle latex which forms an initial charge (known as the “seed latex” polymerization method). By way of example, suitable seed latices are composed of polybutadiene or polystyrene. In principle, it is possible to use the rubbers as graft base after their preparation. However, prior to the grafting they may also first be agglomerated through agglomeration processes to give larger particles.

Agglomeration processes are known to the person skilled in the art. Methods known per se to the person skilled in the art may also be used to undertake the agglomeration process. For example, use may be made of physical methods, such as freeze agglomeration or pressure agglomeration processes. However, it is also possible to use chemical methods to agglomerate the primary particles. Among the latter is the addition of inorganic or organic acids. The agglomeration is preferably undertaken by means of an agglomeration polymer in the absence or presence of an electrolyte, such as an inorganic hydroxide. By way of example, agglomeration polymers which may be mentioned are polyethylene oxide polymers or polyvinyl alcohols. Among suitable agglomeration polymers are copolymers of C₁-C₁₂-alkyl acrylates or of C₁-C₁₂-alkyl methacrylates and of polar comonomers, such as acrylamide, methacrylamide, ethacrylamide, n-butylacrylamide, or maleamide.

The rubbers preferably have particle sizes (weight average d₅₀) in the range from 100 to 2500 nm. The particle size distribution is preferably almost or completely monomodal, or almost or completely bimodal.

The graft copolymers comprise a graft based on an unsaturated monomer, and this means that the graft may also have been prepared from two or more unsaturated monomers. In principle, a very wide variety of unsaturated compounds may be used for grafting to the rubber. Appropriate compounds and methods are known per se to the person skilled in the art. Preference is given to a graft comprising
b21) from 50 to 100% by weight, preferably from 60 to 100% by weight, and particularly preferably from 65 to 100% by weight, of a vinylaromatic monomer,
b22) from 0 to 50% by weight, preferably from 0 to 40% by weight, and particularly preferably from 0 to 35% by weight, of acrylonitrile or methacrylonitrile or a mixture of these,
b23) from 0 to 40% by weight, preferably from 0 to 30% by weight, and particularly preferably from 0 to 20% by weight, of one or more other monoethylenically unsaturated monomers,
   where the proportions of components b21) to b23) give a total of 100% by weight.

Vinylaromatic monomers which may be used are the vinylaromatic compounds as specified under b12), or a mixture composed of two or more of these, in particular styrene or α-methylstyrene. Other monoethylenically unsaturated monomers are, as specified under b12), the aliphatic, aromatic, and araliphatic esters, acids, nitrogen-functional monomers, and unsaturated ethers, and mixtures of these monomers.

However, the graft may also comprise monomers having functional groups, and among these particular mention may be made of epoxy groups or oxazoline groups.

One or more steps of a process may be used to prepare the graft. The monomers here, b21), b22), and b23), may be added individually or in a mixture with one another. The monomer ratio in the mixture may be constant over time or represent a gradient. Combinations of these procedures may also be used.

By way of example, the material polymerized onto the graft base may first be styrene alone, and then a mixture of styrene and acrylonitrile.

By way of example, preferred grafts are composed of styrene and/or of α-methyl-styrene, and of one or more of the other monomers mentioned under b22) and b23). Preference is given to methyl methacrylate, N-phenylmaleimide, maleic anhydride, and acrylonitrile, methyl methacrylate and acrylonitrile being particularly preferred.

Preferred grafts derive from:
b2-1: styrene
b2-2: styrene and acrylonitrile,
b2-3: α-methylstyrene and acrylonitrile,
b2-4: styrene and methyl methacrylate.

The proportion of styrene or α-methylstyrene, or the proportion of the entirety of styrene and α-methylstyrene, is particularly preferably at least 40% by weight, based on the graft.

As mentioned above, other suitable graft copolymers are those with two or more “soft” and “hard” stages, especially if the particles are relatively large.

Preference is given to graft copolymers which comprise (based on the graft copolymer)
b1) from 30 to 95% by weight, preferably from 40 to 90% by weight, in particular from 40 to 85% by weight, of graft base (i.e. rubber), and
b2) from 5 to 70% by weight, preferably from 10 to 60% by weight, in particular from 15 to 60% by weight, of a graft.

By way of example of preferred graft copolymers, mention may be made of those which comprise (based on the graft copolymer),
b1) from 30 to 95% by weight of a graft base comprising (based on b1)) 100% by weight of butadiene, and
b2) from 5 to 70% by weight of a graft comprising (based on b2)) from 65 to 85% by weight of styrene and from 15 to 35% by weight of acrylonitrile.

Other preferred graft copolymers are those which comprise (based on the graft copolymer)
b1) from 30 to 95% by weight of a graft base comprising (based on b1)) from 50 to 97% by weight of butadiene and from 3 to 50% by weight of styrene, and
b2) from 5 to 70% by weight of a graft comprising (based on b2)) from 65 to 85% by weight of styrene and from 15 to 35% by weight of acrylonitrile.

By way of example, among the preferred graft copolymers are also those which comprise (based on graft copolymer))
b1) from 30 to 95% by weight of a graft base comprising n-butyl acrylate and containing a crosslinking agent and
b2) from 5 to 70% by weight of a graft comprising (based on graft)) from 65 to 85% by weight of styrene and from 15 to 35% by weight of acrylonitrile.

The grafting is generally carried out in emulsion. Suitable process measures are known to the person skilled in the art. If ungrafted polymers composed of the monomers b2) are produced, these amounts, which are generally less than 10% by weight of B), are counted with the weight of component D).

The content of component B) in the inventive molding compositions may vary widely. Preferred inventive molding compositions comprise amounts of from 4 to 50% by weight, in particular from 6 to 45% by weight, of component B), based on the total weight of the molding composition. Particularly preferred molding compositions comprise from 8 to 40% by weight of component B), based on the total weight of the molding composition.

Component C)

According to the invention, component C) comprises a rubber-free copolymer. For the purposes of the present invention, this also means that component C) may comprise a mixture of two or more of these copolymers.

Structurally, the copolymer C) is composed of at least 30% by weight, based on the total weight of all of the units present in C), of units (c1) which derive from vinylaromatic monomers. In other respects the structure is variable within wide limits and is especially intended to render the copolymers C) at least to some extent, preferably to a substantial extent, miscible with component B. The nature and amount of the functional groups is also intended to be such that a reaction can take place with the end groups of the polyamides A).

In one of the preferred embodiments, the copolymers C are based on a vinylaromatic compound (c1) and comprise, as units (c2), dicarboxylic anhydrides (c21) or dicarboxylic imides (c22), or a mixture of c21) and c22), and comprise units (c3) which derive from other monomers in which the groups present do not react with the end groups of the polyamide, or react only at a small fraction of the rate.

In this embodiment, the proportion of the units c1) is preferably from 50 to 85% by weight, in particular from 60 to 80% by weight. The copolymers C) very particularly preferably comprise from 65 to 78% by weight of units which derive from aromatic vinyl compounds. In each case, the % by weight data are based on the total weight of c1) to c3).

The proportion of the units c21) which derive from α,β-unsaturated dicarboxylic anhydrides is preferably from 0.3 to 25% by weight. Copolymers C) having substantially less than 0.3% by weight of the units c21), for example those having less than 0.1% by weight of these units, generally lack sufficient reactivity. Those having substantially more than 25% by weight mostly become difficult to process because their crosslinking activity is too high. The copolymers C) preferably comprise from 0.5 to 15% by weight, in particular from 0.7 to 10% by weight, very particularly preferably from 0.8 to 5% by weight, of c21), for example from 1 to 3% by weight of c21). The % by weight data here are in each case based on the total weight of the units c1) to c3).

Instead of the units c21) or, as is preferred, in addition thereto, the copolymers C) may comprise units c22) which derive from α,β-unsaturated, in particular cyclic dicarboxylic imides. These are generally present at from 0 to 49.7% by weight in the copolymers C). Preferred copolymers C) comprise from 0 to 39.5% by weight of c22), in particular from 0 to 34.2% by weight, the % by weight data being based in each case on the total weight of the units c1) to c3).

If the copolymers do not comprise c22), the copolymers C) may moreover also comprise from 14.7 to 40% by weight, preferably from 19.5 to 35% by weight, in particular from 21.3 to 33% by weight, based on the total weight of the units c1) to c3), of units c3) which derive from other compounds capable of free-radical polymerization.

Particular aromatic vinyl compounds c1) which may be used are styrene and styrene derivatives. Among the suitable styrene derivatives are α-methylstyrene and styrene derivatives substituted on the aromatic ring, for example vinyltoluene, tert-butylstyrene, or chlorostyrene. It is, of course, also possible to use a mixture of different aromatic vinyl compounds. It is very particularly preferable to use styrene.

Among the preferred α,β-unsaturated dicarboxylic anhydrides c21) are cyclic compounds, specifically those having from 2 to 20 carbon atoms. The double bond may be either exocyclic or endocyclic. Among these compounds, particular preference is given to maleic anhydride, methylmaleic anhydride, or itaconic anhydride. It is also possible to use a mixture of various dicarboxylic anhydrides. It is very particularly preferable to use maleic anhydride alone.

The α,β-unsaturated dicarboxylic imides c22) generally correspond to the abovementioned dicarboxylic anhydrides. The substituent on the nitrogen is generally a C₁-C₂₀-alkyl, C₄-C₂₀-cycloalkyl, C₁-C₁₀-alkyl-C₆-C₁₈-aryl, or a C₆-C₁₈-aryl radical.

The alkyl radicals may be either linear or branched and may have interruption by one or more oxygen atoms, there being no direct linking of the oxygen atoms to the nitrogen atoms or to another oxygen atom. Among these alkyl radicals are methyl, ethyl, n-propyl, isopropyl, n-butyl, isobutyl, tert-butyl, n-hexyl, n-decyl, and n-dodecyl. The cycloalkyl radicals may be either unsubstituted or substituted. Examples of suitable substituents are alkyl groups, such as methyl or ethyl. Examples which may be mentioned of cycloalkyl radicals are cyclobutyl, cyclopentyl, cyclohexyl, and p-methylcyclohexyl. The alkyl group of the alkylaryl radicals may be either linear or branched, and the alkylaryl radicals may also have substituents. Examples of these substituents are alkyl groups, such as methyl or ethyl, or else halogen atoms, such as chlorine or bromine. Examples of alkylaryl radicals which may be used are benzyl, ethylphenyl, or p-chlorobenzyl. The aryl radicals may also be substituted or unsubstituted, examples of suitable substituents being alkyl groups, such as methyl or ethyl, or halogen atoms, such as chlorine or bromine. Among the preferred aryl radicals are phenyl and naphthyl. Very particularly preferred radicals are cyclohexyl or pheriyl.

By way of example of units c3), mention may be made here of acrylic acid and acrylic acid derivatives, such as methacrylic acid, alkyl acrylates, such as ethyl acrylate, methyl methacrylate, ethyl methacrylate, or cyclohexyl methacrylate, or unsaturated nitriles, such as acrylonitrile, methacrylonitrile. Mixtures of these monomers may likewise be used. It is very particularly preferable to use acrylonitrile alone.

By way of example of preferred copolymers C), mention may be made of those having the following composition:

Copolymers which comprise
c1) from 50 to 85% by weight, preferably from 60 to 81% by weight, of styrene,
c2) from 0.5 to 10% by weight, preferably from 1 to 5% by weight, of maleic anhydride, and
c3) from 14.5 to 40% by weight, preferably from 18 to 35% by weight, of acrylonitrile,
   where the proportions of c1) to c3) give a total of 100% by weight.

The copolymers C) for this embodiment preferably comprise the units c1) to c3) with random distribution. The molar masses M_{w} (weight-average) of the copolymers C) are generally from 30 000 to 500 000 g/mol, preferably from 50 000 to 250 000 g/mol, in particular from 70 000 to 200 000 g/mol, determined by means of GPC using tetrahydrofuran (THF) as eluent and polystyrene calibration.

The copolymers C) for this embodiment may, by way of example, be prepared by free-radical polymerization of the corresponding monomers. This reaction may be carried out either in suspension or in emulsion, or else in solution or in bulk, the latter being preferred. The free-radical reaction may generally be initiated using the usual methods, for example light, or preferably using free-radical initiators, such as peroxides, e.g. benzoyl peroxide. Thermally initiated polymerization is also possible.

Another method of preparing the copolymers C) for this embodiment first reacts components c1), c21), and, if appropriate, c3) with one another in a free-radical reaction, and then converts some of the anhydride groups present within the reaction product into imide groups, using appropriate primary amines or ammonia, thus producing the units c22). This reaction is generally executed in the presence of a tertiary amine as catalyst at temperatures of from 80 to 350° C.

In another preferred embodiment, the copolymers C) comprise, instead of the units c21) or c22) or a mixture of these, units (c23) which derive from an unsaturated monomer which comprises an epoxy group. The units c23) may also be based on a mixture of two or more different monomers of this type. The monomers may have one, or else two or more, epoxy groups. It is particularly preferable to use glycidyl methacrylate alone.

Among the preferred copolymers C) for this embodiment are:

Copolymers comprising
c1) from 65 to 85% by weight, preferably from 70 to 80% by weight, of styrene,
c23) from 0.5 to 10% by weight, preferably from 1 to 5% by weight, of glycidyl methacrylate, and
c3) from 14.5 to 34.5% by weight, preferably from 19 to 29% by weight, of acrylonitrile,
   where the proportions of c1) to c3) give a total of 100% by weight.

The copolymers C) for this embodiment may, for example, be prepared by suspension polymerization in polyvinyl alcohol in the presence of a peroxidic initiator.

The copolymers C) for this embodiment generally have molar masses (weight-average M_{w}) in the range from 50 000 to 1 000 000 g/mol, preferably from 70 000 to 500 000 g/mol, determined by GPC using THF as eluent, against a polystyrene standard.

The amount of component C) generally used in the inventive molding compositions is from 0.95 to 25% by weight, preferably from 1.4 to 20% by weight, in particular from 1.8 to 15% by weight, based on the total weight of the molding composition.

Component D

According to the invention, component D is a rubber-free matrix polymer, a term which also includes mixtures composed of two or more different matrix polymers. The selection of the molecular structure of the matrix polymer is preferably such that the matrix polymer is compatible with the graft. The monomers b2) therefore preferably correspond to those of the matrix polymer. However, the matrix polymers preferably comprise no functional groups which can react with the end groups of the polyamides.

By way of example, amorphous polymers are suitable as matrix polymer. The material here may, for example, be SAN (styrene-acrylonitrile), AMSAN (α-methylstyrene-acrylonitrile), styrene-maleimide-maleic anhydride (SNPMIMA), styrene-maleic acid (anhydride)-acrylonitrile polymers, or SMSA (styrene-maleic anhydride).

Component D therefore preferably comprises a copolymer composed of
d1) from 60 to 100% by weight, preferably from 65 to 80% by weight, of units of a vinylaromatic monomer, preferably of styrene, of a substituted styrene, or of a (meth)acrylic ester, or a mixture of these, in particular of styrene or α-methyl-styrene, or a mixture of these,
d2) from 0 to 40% by weight, preferably from 20 to 35% by weight, of units of an ethylenically unsaturated monomer, preferably of acrylonitrile or of methacrylonitrile or of methyl methacrylate, in particular of acrylonitrile.

In one embodiment of the invention, the matrix polymer here is composed of from 60 to 99% by weight of vinylaromatic monomer and from 1 to 40% by weight of at least one of the other monomers stated.

In one embodiment of the invention, a copolymer of styrene and/or α-methylstyrene with acrylonitrile is used as matrix polymer. The acrylonitrile content in these copolymers is from 0 to 40% by weight, preferably from 18 to 35% by weight, based on the total weight of the matrix polymer.

The molar masses (weight-average M_{w}) are generally in the range from 50 000 to 500 000 g/mol, preferably in the range from 70 000 to 450 000 g/mol.

The matrix polymers are known per se or may be prepared by methods known to the person skilled in the art.

The content of component D) in the thermoplastic molding compositions is generally from 0 to 50% by weight, preferably from 1 to 45% by weight, in particular from 1 to 40% by weight, based on the total weight of the molding composition.

Component E)

A low-molecular-weight compound which has only one dicarboxylic anhydride group may be used concomitantly as further component. However, it is also possible to use two or more of these compounds as component E). These compounds may comprise, besides the dicarboxylic anhydride group, other functional groups which can react with the end groups of the polyamides. Examples of suitable compounds E) are C₄-C₁₀-alkyldicarboxylic anhydrides, such as succinic anhydride, glutaric anhydride, adipic anhydride. Use may also be made of cycloaliphatic dicarboxylic anhydrides, such as 1,2-cyclohexanedicarboxylic anhydride. It is moreover also possible to use dicarboxylic anhydrides which are ethylenically unsaturated or aromatic compounds, e.g. maleic anhydride, phthalic anhydride, or trimellitic anhydride.

The content of component E) is generally from 0 to 3% by weight, preferably from 0.001 to 2% by weight, based on the total weight of components A to F.

Component F)

The molding compositions may comprise additives. Their content is generally from 0 to 60% by weight, preferably from 0 to 50% by weight, based on the total weight of components A to F.

Examples of fillers which may be used are particulate mineral fillers. Suitable substances among these are amorphous silica, carbonates, such as magnesium carbonate (chalk), powdered quartz, mica, a very wide variety of silicates, such as clays, muscovite, biotite, suzoite, tin maletite, talc, chlorite, phlogophite, feldspar, calcium silicates, such as wollastonite, or kaolin, particularly calcined kaolin.

In one particularly preferred embodiment, use is made of particulate fillers of which at least 95% by weight, preferably at least 98% by weight, of the particles have a diameter (largest dimension), determined on the finished product, of less than 45 μm, preferably less than 40 μm, and for which the ratio known as the aspect ratio is preferably in the range from 1 to 25, with preference in the range from 2 to 20, determined on the finished product, i.e. generally on an injection molding. An example of a method of determining this particle diameter records electron micrographs of thin sections of the polymer mixture and utilizes at least 25, preferably at least 50, filler particles for evaluation. The particle diameters may also be determined by sedimentation analysis, as in Transactions of ASAE, p. 491 (1983). The proportion of the fillers by weight which is less than 40 μm may also be measured by means of sieve analysis. The aspect ratio is the ratio of particle diameter to thickness (largest dimension to smallest dimension).

The particulate fillers used particularly preferably comprise talc, kaolin, such as calcined kaolin, or wollastonite, or a mixture of two or all of these fillers. Among these, particular preference is given to talc with a proportion of at least 95% by weight of particles whose diameter is smaller than 40 μm and whose aspect ratio is from 1.5 to 25, in each case determined on the finished product. Kaolin preferably has a proportion of at least 95% by weight of particles whose diameter is smaller than 20 μm and whose aspect ratio is from 1.2 to 20, determined in each case on the finished product. These fillers may be used in amounts of from 0 to 40% by weight, preferably up to 30% by weight, based on the total weight of A to F.

The component F) used may also comprise fibrous fillers, such as carbon fibers, potassium titanate whiskers, aramid fibers, or preferably glass fibers, at least 50% by weight of the fibrous fillers (glass fibers) having a length of more than 50 μm. The (glass) fibers used may preferably have a diameter of up to 25 μm, particularly preferably from 5 to 13 μm. It is preferable for at least 70% by weight of the glass fibers to have a length of more than 60 μm. In the finished molding, the average length of the glass fibers is particulary preferably from 0.08 to 0.5 mm. The length of the glass fibers relates to a finished molding, for example one obtained by injection molding. The glass fibers added to the molding compositions may either be continuous-filament strands (rovings) or may previously have been converted to the appropriate length. The amounts used of these fibers, based on the total weight of A to F, are generally from 0 to 60% by weight, preferably up to 50% by weight.

Phosphorus-containing flame retardants may be used as component F). Examples are tris(2,6-dimethylphenyl)phosphate, triphenyl phosphate, tricresyl phosphate, diphenyl 2-ethylcresyl phosphate, diphenyl cresyl phosphate, tris(isopropylphenyl)phosphate, and also diphenyl 4-phenyl phosphate, phenyl bis(4-phenylphenyl)phosphate, tris(4-phenylphenyl)phosphate, diphenyl benzylphenyl phosphate, phenyl bis(benzylphenyl)phosphate, tris(benzylphenyl)phosphate, phenyl bis(1-phenylethylphenyl)phosphate, phenyl bis(1-methyl-1-phenylethylphenyl)phosphate, and phenyl bis[4-(1-phenethyl)-2,6-dimethylphenyl]phosphate. They may also be used in a mixture with triphenylphosphine oxide or tris(2,6-dimethylphenyl)phosphine oxide.

Other preferred flame retardants are resorcinol diphosphate and higher oligomers of the same, hydroquinone diphosphate, and higher oligomers of the same.

The amounts generally used of the flame retardants are from 0 to 20% by weight, preferably from 0 to 17.5% by weight. If they are present, the amounts present are preferably from 0.4 to 10% by weight. In each case, the amounts given are based on the total weight of A to F.

Examples of other additives which may be mentioned are processing aids, stabilizers, and oxidation retarders, agents to counter decomposition by heat and decomposition by ultraviolet light, lubricants, and mold-release agents, dyes, and pigments, and also plasticizers. The proportion of these is generally from 0 to 45% by weight, preferably from 0 to 20% by weight, in particular 0% by weight, and if they are present from 0.2 to 10% by weight, based on the total weight of A to F.

The amounts generally present of pigments and dyes are from 0 to 4% by weight, preferably 0 to 3.5% by weight, and in particular 0% by weight, and if they are present from 0.5 to 3% by weight, based on the total weight of A to F.

The pigments for coloring thermoplastics are well-known. A first preferred group of pigments which may be mentioned is that of white pigments, such as zinc oxide, zinc sulfide, white lead (2PbCO₃.Pb(OH)₂), lithopones, antimony white, and titanium dioxide. Of the two most commonly encountered crystalline forms (rutile and anatase) of titanium dioxide, it is in particular the rutile form that is used for white coloring of the molding compositions of the invention.

Black color pigments which may be used according to the invention are iron oxide black (Fe₃O₄), spinel black (Cu(Cr,Fe)₂O₄), manganese black (a mixture of manganese dioxide, silicon oxide, and iron oxide), cobalt black, and antimony black, and also particularly preferably carbon black, which is mostly used in the form of furnace black or gas black.

To establish particular shades of color, inorganic color pigments may, of course, be used according to the invention. It can moreover be advantageous to use the pigments and, respectively, dyes mentioned in a mixture, e.g. carbon black with copper phthalocyanines, because the dispersion of the color in the thermoplastic is generally rendered easier.

Examples of oxidation retarders and heat stabilizers which may be added to the thermoplastic compositions of the invention are halides of metals of group I of the periodic table, e.g. sodium halides, lithium halides, if appropriate in combination with cuprous halides, e.g. with chlorides, bromides, or iodides. The halides, in particular those of copper, may also contain electron-rich p ligands. As an example of these copper complexes, mention may be made of copper halide complexes with, for example, triphenylphosphine. Zinc fluoride and zinc chloride may also be used. Other compounds which may be used are sterically hindered phenols, hydroquinones, substituted members of this group, secondary aromatic amines, HALS, if appropriate in combination with phosphorus-containing acids or their salts, and mixtures of these compounds, preferably at concentrations of up to 2% by weight, based on the total weight of A to F.

Examples of UV stabilizers are various substituted resorcinols, salicylates, benzotriazoles, and benzophenones, which are usually used in amounts of up to 2% by weight, based on the total weight of A to F.

Lubricants and mold-release agents, which are generally used in amounts of up to 1% by weight, based on the total weight of A to F, are stearic acid, stearyl alcohol, alkyl stearates, and stearamides, and esters of pentaerythritol with long-chain fatty acids. It is also possible to use calcium stearate, zinc stearate, or aluminum stearate, or else dialkyl ketones, e.g. distearyl ketone. Other lubricants and mold-release agents which may be used are ethylene oxide-propylene oxide copolymers.

It has been found that addition of stearates or silicone oils in amounts of from 0.3 to 1.5% by weight, based on the total weight of the molding compositions, can considerably reduce the formation of flow lines during processing. The moldings composed of the molding compositions in which these additives are present are moreover particularly scratch-resistant. The amounts of the stearates or silicone oil preferably added for this purpose are in the range from 0.3 to 1.3% by weight, in particular from 0.5 to 1% by weight, based on the total weight of the molding compositions.

Use may be made here, for example, of the abovementioned salts of stearic acid. It is also possible to use a mixture composed of two or more different salts of stearic acid. Silicone oils used are preferably those derived from linear polysiloxanes. Linear polydimethylsiloxanes are particularly preferred. Among the particularly preferred silicone oils are those whose viscosity is in the range from 20 to 100 000 mPas (dynamic viscosity at 25° C.), preferably from 100 to 60 000 mpas.

It is also possible to use a mixture composed of two or more different silicone oils. Mixtures composed of one stearate, or of a mixture of different stearates, with one silicone oil, or a mixture of different silicone oils, may likewise be used. By way of example, use may be made of a mixture composed of calcium stearate with polydimethylsiloxane. However, it is preferable to use either one stearate or one silicone oil alone. Calcium stearate is used as particularly preferred stearate and polydimethylsiloxane is used as particularly preferred silicone oil. It has proven very particularly advantageous to use calcium stearate alone.

There is a very wide variety of methods for introducing the stearate or the silicone oil or their mixtures into the molding compositions. By way of example, they may be fed separately or in a mixture. By way of example, it is possible to here to add these additives together with the other components or after addition of some of the other components, and to mix them with these. However, it is also possible to delay addition of these additives, by way of example, until the molding compositions have been pelletized, and to apply them to the surface of the pellets.

The inventive thermoplastic molding compositions may be prepared by processes known per se, via mixing of component A) with components B) and C), and also, if present, with components D) to F). All of the components here may be mixed together with one another. However, it can also be advantageous to premix individual components. It is also possible, although less preferred, to mix the components in solution with removal of the solvents.

According to one embodiment of the invention, it is preferable to premix component C) and a portion of component A) in the form of their pellets and then to melt these together and react them to give graft copolymer P). This process may use the mixture of different copolymers C), or else only one copolymer C). In principle, a very wide variety of methods may be used for mixing the pellets with one another, for example manual, turbine mixer, fluid mixer, Rohnrad mixer. It is particularly preferable to mix the pellets with one another at room temperature by means of a turbine mixer and within a period of from 1 to 5 minutes.

The melting assembly used may comprise, by way of example, Maxwell mixers, Banbury mixers, kneaders, Buss co-kneaders, Farrell kneaders, or single-, twin-, or multiple-screw extruders, for example a ring extruder or a planetary-gear extruder.

In the case of the twin-screw extruders, use may be made of those with corotating screws or those with counterrotating screws, particular preference being given to those with intermeshing corotating screws. The corotating twin-screw extruders preferably used generally have at least one feed section provided with forward-conveying screw elements, at least one homogenizing section provided with kneading and reverse-conveying elements, and with at least one mixing section with forward-conveying, reverse-conveying, and kneading elements. It is also possible here to use specific mixing elements, such as toothed mixing elements, melt mixing elements, or turbine mixing elements. The extruders preferably comprise one feed section, one homogenization section, and one mixing section. The preferred extruders mostly also have one, two, or more devolatilization sections. These particularly preferably follow the (last) mixing section. The devolatilization sections may be operated at atmospheric pressure, at superatmospheric pressure, or in vacuo. It is preferable for the devolatilization sections to be operated at atmospheric pressure or in vacuo. It is particularly preferable for the devolatilization sections to be operated under a vacuum of from 10 to 900 mbar, preferably from 20 to 800 mbar, in particular from 30 to 600 mbar. Following the devolatilization section(s), the preferred extruders generally have a metering section and a pelletizing unit. The latter may, for example, be a strand pelletizer, an underwater pelletizer, or a water-cooled die-face pelletizer, preference being given to strand pelletizers and underwater pelletizers. The metering section may, of course, also instead be an injection-molding unit.

The temperature during the preparation of the graft copolymers P) by the melt process is generally in the range from 200 to 350° C., preferably in the range from 220 to 340+ C.

If the entire amount of component C) is reacted with a portion of component A) to give the graft copolymers P), the amount of component A) may vary within a wide range. The portion used of A) should, however, be judged so that firstly an adequate amount of graft copolymer P) is formed and secondly there is no great excess of polyamide alongside the graft copolymer P). The graft copolymers P) may comprise from 5 to 95% by weight, preferably from 10 to 90% by weight, of copolymer C) and from 5 to 95% by weight, preferably from 10 to 90% by weight, of polyamide A). The amount of polyamide is particularly preferably judged so that the molar ratio of the functional groups of component C) to the end groups of the polyamide is from 0.8:1 to 1.3:1, preferably from 0.9:1 to 1.3:1.

The resultant graft copolymers P) may be mixed with the remainder of component A), and also with the other components, if present. Any of the known methods may be used for mixing the components, which may, for example, be dry. The mixing preferably takes place at temperatures of from 200 to 320° C. by extruding, kneading, or roll-milling the components together, the components having been isolated in advance, if appropriate, from the solution obtained during polymerization or from the aqueous dispersion.

The inventive thermoplastic molding compositions may be processed by the known processes for thermoplastics processing, e.g. by extrusion, injection molding, calendering, blow molding, or sintering.

The inventive molding compositions may be used to produce films, fibers, moldings, or foams. They may particularly preferably also be processed for producing vehicle-interior parts. In one of the preferred embodiments, the inventive thermoplastic molding compositions may serve as substrate material whose surface has been entirely or partially metallized.

### EXAMPLES

The viscosity number of the polyamides was determined to DIN 53 727 on 0.5% strength by weight solutions in 96% strength by weight sulfuric acid at 23° C.

The viscosity number of the terpolymer and of the styrene-acrylonitrile copolymer (SAN) was determined in dimethylformamide at 25° C. on 0.5% strength by weight solutions.

The particle size of the graft rubbers is the weight average d₅₀, determined as in W. Scholtan and H. Lange, Kolloid-Z. und Z.-Polymere 250 (1972), pp 782-796, by means of an analytical ultracentrifuge.

The heat resistance of the specimens was determined by means of the Vicat softening point. The Vicat softening point was determined to DIN 53 460, on standard small specimens, using a force of 49.05 N and a temperature rise of 50 K per hour.

The notched impact strength (ak) of the products was determined on ISO specimens to ISO 179 1eA.

Flowability (melt volume index, MVI) was determined to ISO 1133 at 240° C. with 5 kg load.

Melt viscosity was determined in a capillary rheometer at a temperature of 290° C. and a shear rate of 55 Hz. To characterize processing stability, the melt viscosity was determined after 4 and 24 minutes of residence time in the capillary rheometer under these conditions. The table gives the change during the residence time, based on the value measured at 4 minutes.

Frictional properties were determined to ISO 8925, 199E(E), on sheets of the respective molding composition. The variable (ΔC_{F}) used, which correlates with the tendency of plastics parts to squeak, was the difference in coefficients of friction in what is known as the “stick/slip” region.

Component A₁

The polyamide A2₁ used comprised a nylon-6, obtained from ε-caprolactam, with a viscosity number of 150 ml/g.

Component A₂

The polyamide A2₁ used comprised a nylon-6, obtained from ε-caprolactam, with a viscosity number of 125 ml/g.

Component B₁

Graft rubber having 62% by weight of polybutadiene in the core and 38% by weight of a graft shell composed of 75% by weight of styrene and 25% by weight of acrylonitrile. Particle size about 400 nm.

Component B₂

Graft rubber having 70% by weight of polybutadiene in the core and 30% by weight of a graft shell composed of 75% by weight of styrene and 25% by weight of acrylonitrile. Particle size about 370 nm.

Component B₃

Graft rubber having 85% by weight of polybutadiene in the core and 15% by weight of a graft shell composed of 75% by weight of styrene and 25% by weight of acrylonitrile. Particle size about 390 nm.

Component B₄

Graft rubber having 66% by weight of polybutadiene in the core and 34% by weight of a graft shell composed of 75% by weight of styrene and 25% by weight of acrylonitrile. Particle size about 375 nm.

Component C₁

Styrene-acrylonitrile-maleic anhydride terpolymer whose composition was 74/23.5/2.5 (% by weight), viscosity number: 80 ml/g

Component D₁

Styrene-acrylonitrile copolymer having 75% by weight of styrene and 25% by weight of acrylonitrile and having a viscosity number of 80 ml/g

Component E₁

Phthalic anhydride

Preparation of molding compositions

The components were mixed in a twin-screw extruder at a melt temperature of from 240 to 260° C. The melt was passed through a water bath and pelletized.

The results of the tests are listed in table 1.

TABLE 1

| | Molding composition | | | | | | |
|---|---|---|---|---|---|---|---|
| | 1C | 2C | 3 | 4 | 5 | 3C | 6 |
| Composition | | | | | | | |
| A1 | 40.8 | — | 40.8 | 40.8 | 40.8 | 40.8 | 40.8 |
| A2 | — | 41 | — | — | — | — | — |
| B1 | 35 | 35 | 32 | 33 | 20 | 27 | — |
| B2 | — | — | 3 | | — | — | — |
| B3 | — | — | — | 2 | — | — | 20 |
| B4 | — | — | — | | 15 | — | 7 |
| C1 | 5 | 5 | 5 | 5 | 5 | 5 | 5 |
| D1 | 19 | 19 | 19 | 19 | 19 | 27 | 27 |
| E1 | 0.2 | 0.2 | 0.2 | 0.2 | 0.2 | 0.2 | 0.2 |
| Properties | | | | | | | |
| Δ Rubber content | — | — | 8 | 23 | 21 | — | 21 |
| [% by weight] | | | | | | | |
| Vicat B [° C.] | 105 | 104 | 105 | 106 | 105 | 108 | 105 |
| ak, RT | 51 | 24 | 64 | 66 | 52 | 21 | 63 |
| [kJ/m²] | | | | | | | |
| ak, 130° C. [kJ/m²] | 15 | 11 | 18 | 19 | 14 | 9 | 17 |
| MVI [ml/10′] | 5.2 | 10.1 | 7.9 | 8.1 | 6.2 | 11.8 | 7.2 |
| MVI change [%] | −51 | −43 | −12 | −10 | −39 | −34 | −14 |
| ΔC_{F} | 0.05 | 0.05 | 0.04 | 0.04 | 0.02 | 0.06 | 0.03 |

1-11. (canceled)

12. A thermoplastic molding composition composed of
A) a polyamide having amino or carboxy end groups or a mixture of these end groups,
B) a mixture composed of at least two graft copolymers, each comprising a rubber as graft base and a graft based on an unsaturated monomer, where these differ at least 5% by weight from one another in their rubber contents,
C) a rubber-free copolymer, comprising
c1) at least 30% by weight, based on the total weight of all of the units present in C), of units which derive from a vinylaromatic monomer,
c2) units which derive from a monomer which comprises a functional group which can react with the end groups of the polyamide A), and
c3) units which derive from a monomer which comprises no functional groups which react with the end groups of the polyamide A),
E) a low-molecular-weight compound which comprises a dicarboxylic anhydride group, and also moreover, optionally,
D) a rubber-free matrix polymer, and
F) an additive, or a mixture of various additives.

13. The thermoplastic molding composition according to claim 12 in which each of the graft copolymers is an ABS.

14. The thermoplastic molding composition according to claim 12, in which component A) is nylon-6.

15. The thermoplastic molding composition according to claim 13, in which component A) is nylon-6.

16. The thermoplastic molding composition according to claim 12, in which component C) is a terpolymer composed of styrene, maleic anhydride, and acrylonitrile.

17. The thermoplastic molding composition according to claim 15, in which component C) is a terpolymer composed of styrene, maleic anhydride, and acrylonitrile.

18. The thermoplastic molding composition according to claim 12, in which component F) comprises a stearate or a silicone oil or a mixture thereof.

19. The thermoplastic molding composition according to claim 17, in which component F) comprises a stearate or a silicone oil or a mixture thereof.

20. A process for preparing thermoplastic molding composition according to claim 12, which comprises, in a first step, preparing a graft copolymer P) from a portion of component A) and from the entire amount of component B), and, in a second step, mixing the graft copolymers P) with the other components and with the remainder of component A).

21. A molding, film, fiber or foam, obtainable using thermoplastic molding composition according to claim 12.

22. A molding, film, fiber or foam prepared according to the process of claim 20.

23. The molding, film, fiber or foam according to claim 21 wherein the molding, film, fiber or foam has improved frictional properties.

24. A molding according to claim 21, whose Δ C_{F} value is less than 0.05, measured to ISO 8925, 199E (E).

25. Motor-vehicle-interior parts, obtainable using moldings, films, fibers, or foams according to claim 22.
